(19) United States
(12) Patent Application Publication
(10) Pub. No.: US 2007/0231558 A1
(43) Pub. Date: Oct. 4, 2007

(54) Porous film sheet and production method thereof

(75) Inventors: Akito Kamatani, Kanagawa (JP); Hidekazu Yamazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/727,525

(22) Filed: Mar. 27, 2007

(30) Foreign Application Priority Data
Mar. 27, 2006 (JP) 2006-086568

(51) Int. Cl. B32B 3/10; B32B 3/26; B29C 65/00

(52) U.S. Cl. 428/304.4; 428/131; 264/41

(57) ABSTRACT

A honeycomb film as a porous film includes a support and a honeycomb film as a porous film formed on the support. A polymer solution is applied to the support to form a wet layer, and water droplets are formed in the wet layer. Thereafter the water droplet is dried to form pores in the wet layer, such that the wet layer may be the honeycomb film. Thus the honeycomb film is obtained, and when it is piled or wound for storing, it is not damaged or torn.

### FIELD OF THE INVENTION

The present invention relates to a porous film and a production method thereof.

### BACKGROUND OF THE INVENTION

In recent years, the higher integration degree, the higher density of information, and the higher definition of image are moreover expected in the field of the optical materials and the electric materials. Therefore, the forming of the fine structure (the fine patterning), is also required to the film to be used in such fields. The fine structure of the film is called a fine pattern structure in the following explanation. In the field of the research for the regenerative medicine, a film having a surface of the fine structure is effectively used as a base material for the cell culture (for example, Japanese Patent Laid-Open Publication 2001-157574).

For the fine patterning of the film, there are several methods, such as a deposition method with use of mask, an optical lithography in which the photochemical reaction and the polymerization, and a laser-ablation and the like.

Further, as described in the Japanese Patent Laid-Open Publication No. 2002-335949, when the dilute solution of the polymer having a specific structure is cast under high humidity, the film to be produced has a honeycomb structure of micron scale. In this case, the film production is sometimes designated such that the film having the honeycomb structure may contain functional micro particles, and thus the produced film is used as optical and electric material. For example, in the Japanese Patent Laid-Open Publication No. 2003-128832, the luminescence material is contained in the film, and the film is used for a displaying device.

Further, the film having the surface of the fine pattern is also used for a polarizing filter as the optical material. For example, there is a film provided with the moth-eye structure so as to have an antireflective function. This film has the well-regulated fine pattern in the range of submicron to dozen microns. The main production method of this film is described in the Japanese Patent Laid-Open Publication No. 2003-302532. In this method, a plate is formed with use of a micro processing technology, mainly the optical lithography, and the structure of the plate is copied to the film.

The method described in the publication No. 2003-302532 is called the top-down method, in which the plate for determining the fine structure as described above is produced. In order to produce the plate, many complicated processes are necessary, which cause the increase of the cost. Furthermore, it is hard to produce the plate of the large size. Therefore, a bottom up method is supposed as the production method of the film. In the bottom up method, the well-regulated fine pattern having self-organizing effect is formed in a manner of the self organization, and thus a honeycomb porous film is produced so as to have the self-organized structure with the fine pattern.

According to the film storage, in the case that the usual produced porous film is a continuous type, it is wound up to be a film roll, and otherwise, in the case that the produced porous film is an incontinuous type (namely, a sheet type, a strip type and the like), a plurality of the incontinuous film is piled up. However, since the strength of the honeycomb porous film is not so strong, the structure of the film sometimes destructed in effect of tightening force caused at the winding in the film roll of the continuous type or the gravity and weight of the upper one to the lower one among the piled films of the continuous type. Therefore, a spacer is provided between the piled sheet type film, in which increases the cost. Further, the workability of providing the spacer hardly becomes larger, which also increases the cost.

Furthermore, the porous film is very thin. Therefore, in view of the strength, the handling must be made carefully, which decreases the workability. Further, since the porous film is usually formed from a nonconductive material, the static electricity easily charged and the materials near the film is adsorbed to the film. Thus the film is polluted, scratched or damaged.

### SUMMARY OF THE INVENTION

An object of the present invention is to provide a porous film and a production method thereof which has enough strength at the rolling and the piling after the film production.

Another object of the present invention is to provide a porous film and a production method thereof which is hardly damaged and scratched.

In order to achieve the object and the other object, a porous film of the present invention includes a base material and a porous material formed on the base material, and the porous material is reinforced by the base material.

Preferably, the film material has a thicker part and a thinner part. Particularly the base material has an asperity part. Particularly, the asperity part is formed by knurling the base material.

Preferably a first surface of the base material contacts to the porous material and has a protrusion higher than a top of said porous material. Particularly preferably, the protrusion contacts to both edges of the porous material. Especially preferably, edges of the base material are positioned on or outside edges of a product size of the porous material.

Preferably, the base material has an opening. Preferably, the base material has perforations or scores for separating part of the base material. Preferably the porous film is firmly attached to the base material. Preferably the base material is peelable from the porous film. Preferably at least one of the base material and the porous film is conductive.

In a production method of a porous film having a base material and a porous film of the present invention, a solid material is dissolved to a solvent such that a solution may be obtained, the solution is applied to the base material so as to form a wet layer on the base material, a liquid droplet is formed in the wet layer, and the evaporation of the liquid droplet is performed so as to form pores in the wet layer, such that the wet layer may become the porous layer.

Preferably, part of the base material is cut off after the evaporation.

Preferably, perforations or scores are previously formed on the base material before coating, such that part of the base material may be removable.

Preferably, at least one of the base material and the porous film is conductive.

According to the present invention, the produced porous film includes the base material and the porous layer formed on the first surface of the base material, while a plurality of the pores is arranged in the porous layer minutely on pattern. Therefore, after the production of the porous film, the porous film has an adequate strength not so as to be damaged or scratched when piled on another one or rolled.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is an explanatory view of a production line of a honeycomb film as a porous film of the present invention;

FIG. 2 is a schematic diagram of an embodiment of the production line of the honeycomb film;

FIGS. 3A-3D are cross-sectional views illustrating situations of forming the honeycomb film;

FIG. 4A is a plan view of a first embodiment of the honeycomb film;

FIG. 4B is a sectional view of the honeycomb film along a line b-b in FIG. 4A, in which a honeycomb film of the honeycomb film is through hole type;

FIG. 4C is a sectional view of the honeycomb film along a line c-c in FIG. 4A;

FIG. 4D is a sectional view of the honeycomb film, in which the honeycomb film is recess type.

FIG. 5 is a partial perspective view of the honeycomb film of FIG. 4A;

FIG. 6 is a sectional view of a film roll of the honeycomb film of FIG. 5 that are wound up;

FIG. 7A is a schematic diagram of another embodiment of the production line of the honeycomb film;

FIG. 7B is a perspective view of the honeycomb film of FIG. 7A;

FIG. 7C is a sectional view of the honeycomb films of FIG. 7B that are piled up;

FIG. 8 is a perspective view of a second embodiment of the honeycomb film;

FIG. 9 is a sectional view of the honeycomb films of FIG. 8 that are piled up;

FIG. 10 is a perspective view of a third embodiment of the honeycomb film;

FIG. 11 is a sectional view of the honeycomb films of FIG. 10 that are piled up;

FIG. 12 is a perspective view of a fourth embodiment of the honeycomb film;

FIG. 13 is a sectional view of the honeycomb films of FIG. 12 that are piled up;

FIG. 14 is a perspective view of a fifth embodiment of the honeycomb film;

FIG. 15 is a sectional view of the honeycomb films of FIG. 14 that are piled up;

FIG. 16 is a perspective view of a rear side of a sixth embodiment of the honeycomb film;

FIG. 17 is a sectional view of the honeycomb films of FIG. 16 that are piled up;

FIG. 18 is a perspective view of a rear side of a seventh embodiment of the honeycomb film;

FIG. 19 is a sectional view of the honeycomb films of FIG. 18 that are piled up;

FIG. 20 is a perspective view of a rear side of an eighth embodiment of the honeycomb film;

FIG. 21 is a sectional view of the honeycomb films of FIG. 20 that are piled up;

FIG. 22 is a perspective view of a rear side of a ninth embodiment of the honeycomb film;

FIG. 23 is a perspective view of a rear side of a tenth embodiment of the honeycomb film;

FIG. 24 is a perspective view of a rear side of an eleventh embodiment of the honeycomb film;

FIG. 25 is a perspective view of a rear side of a twelfth embodiment of the honeycomb film;

FIG. 26 is a perspective view of a rear side of a thirteenth embodiment of the honeycomb film; and

FIG. 27 is a perspective view of a rear side of a fourteenth embodiment of the honeycomb film.

### PREFERRED EMBODIMENTS OF THE INVENTION

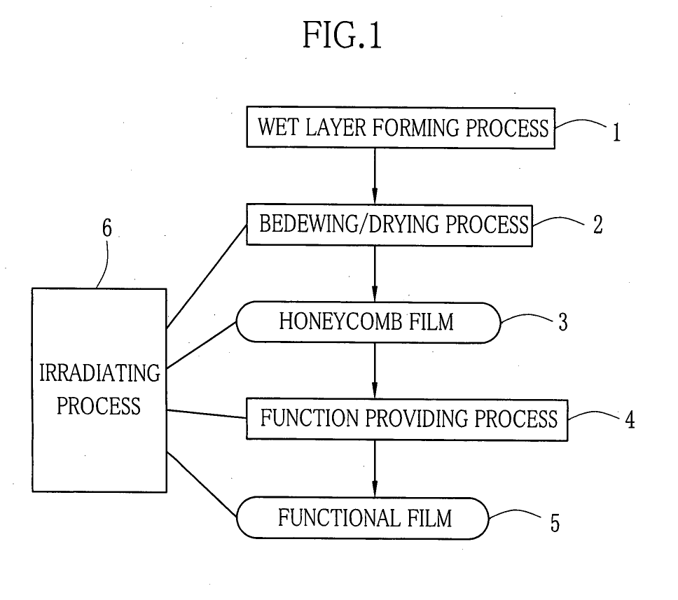

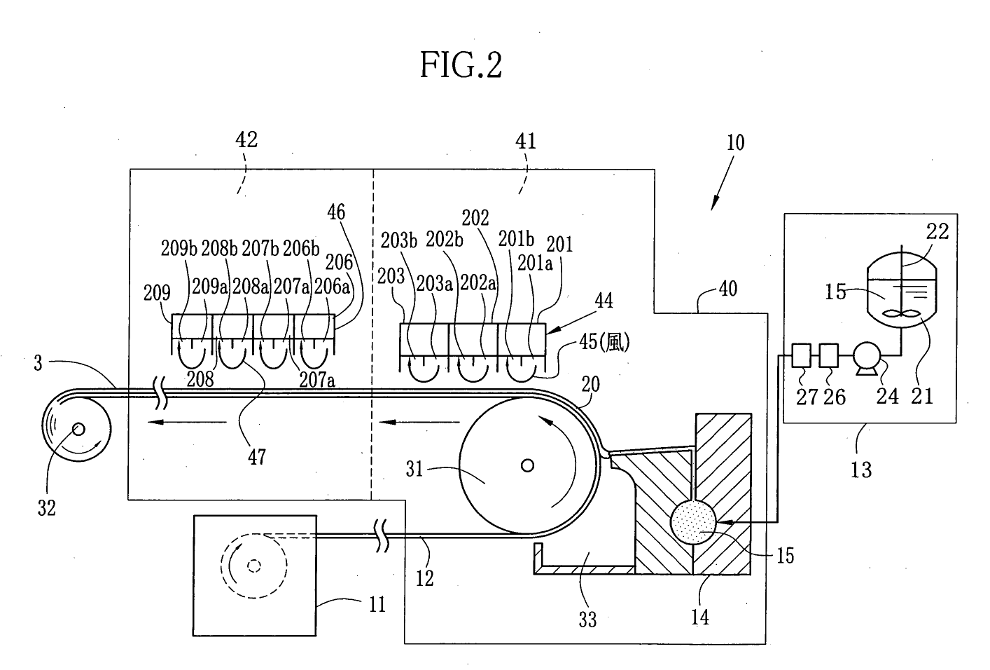

In FIG. 1, a micro-porous film (hereinafter porous film) to be produced in the present invention is called a honeycomb film 3. In this embodiment, a wet layer forming process 1 and a bedewing/drying process 2 are performed such that a porous film having a honeycomb structure may be obtained as the honeycomb film 3, and a function providing process 4 is performed to the honeycomb film 3, such that the functional film 5 may be obtained. In the wet layer forming process 1, a polymer solution (described later in detail) is applied to a continuous support or web 12 to form a wet layer 20 (see, FIG. 2). In the bedewing/drying process 2, the bedewing is made such that water droplets may be formed on and absorbed into the wet layer 20. Then the solvent for the polymer solution and the water droplets are evaporated such that the honeycomb film 3 may be obtained. Note that the more detailed explanation of the bedewing/drying process 2 will be made later. In the function providing process 4, functional materials are applied or provided to the honeycomb film 3, such that the honeycomb film 3 may be obtained from the honeycomb film 3. Note that an irradiating process 6 may be performed during the period for obtaining the honeycomb film 3 from the wet layer 20, such that an illumination is radiated to the honeycomb film 3. In this case, the illumination may be an UV ray or electron ray.

The honeycomb film 3 contains polymers as a main component. The polymers are not restricted especially, and can be determined depending on the use. However, preferably, the polymers can be easily dissolved to the solvent having insolubility in water, namely hydrophobic solvent. The compound of such polymer is, for example, poly-ε-caprolactone, poly-3-hydroxybutylate, agarose, poly-2-hydroxyethylacrylate, polysulfone and the like. However, the biodegradability is sometimes necessary. In this case, the particularly preferable polymer compound is poly-ε-caprolactone, since the cost is low and it is easily obtained. Further, poly-ε-caprolactone is especially preferable when the high biodegradation is necessary. Note that since the hydrophobic character usually means the lipophilic character, the polymer dissolvable to the hydrophobic solvent is called a lipophilic polymer.

The lipophilic polymer is not restricted especially, and selected adequately from the already known polymers, in accordance with the objects. For example, there are vinyl-type polymer (for example, polyethylene, polypropylene, polystyrene, polyacrylate, polymethacrylate, polyacrylamide, polymethacrylamide, polyvinyl chloride, polyvivylidene chloride, polyvinylidene fluoride, polyhexafluoropropene, polyvinyl ether, polyvinylether, polyvinylcarbazol, polyvinyl acetate, polytetrafluoro ethylene, and the like), polyesters (for example, polyethylene terephthalate, polyethylene naphthalate, polyethylene saccinate, polybutylene saccinate, polylactic acid, and the like), polylactone (for example, polycaprolactone, and the like), polyamide/polyimide (for example, nylon, polyamide, and the like), polyurethane, polyurea, polycarbonate, polyaromatics, polysulfone, polyethersulfone, polysiloxane derivative, and the like. These may be used as homo polymer, and otherwise used as copolymer or polymer blend if necessary, in view of solubility, optical physical properties, electric physical property, film strength, elasticity and the like. Note that two or more sorts of the above polymers may be mixed for use.

Although the honeycomb film 3 can be produced from the lipophilic polymer, it is preferable that amphiphilic compound is added to the lipophilic polymer. The amphiphilic compound means a compound having both of the hydrophilic character and the lipophilic character. The preferable amphiphilic compound is polymer, for example, amphiphilic polyacryl amide and the like. Note that a mixture ratio of the lipophilic polymer to the amphiphilic polymer is not restricted especially. However, it is preferably in the range of 5:1 to 20:1.

The amiphiphilic compound is not restricted especially, and can be chosen in accordance with object. There are, for example, a compound which has a main chain of polyacrylamide, a lipophilic side chain of dodecyl group and hydrophilic side chain of carboxyl group, block copolymer of polyethylene glycol/polypropylene glycol, and the like. The lipophilic side chain is nonpolar normal (linear) chain of alkylene, phenylene and the like, and preferably has a structure in which hydrophilic group (for example polar group or ionic dissociative group) doesn't divide until the end of the chain. The lipophilic side chain preferable has at least five methylene units if it is composed of alkylene group. The hydrophilic side chain composed of alkylene group preferably has a structure having hydrophilic part, such as oxyethylene group, polar group or ionic dissociative group at an end of the alkylen group.

A ratio of the lipophilic side chain and hydrophilic side chain is different, depending on sizes thereof, strength of polarity, height of hydrophobicity in the hydrophobic organic solvent, and the like. Therefore it is complicated to decide the ratio. However, the unit ratio ((lipophilic side chain)/(hydrophilic side chain)) is in the rnge of 3/1 to ⅓. Further, in case of copolymer, the preferable polymer is the block copolymer than the alternating polymer, while the lipophilic side chain and the hydrophilic side chain form a block in the block copolymer so far as the block has no influence of solubility to the hydrophobic solvent.

The number average molecular weight (Mn) of the polymer is preferably in the range of 10,000 to 10,000,000, and especially 5,000 to 1,000,000.

The lipophilic polymer and the amphiphilic polymer may be polymerizable (cross-linkable) polymer. Further, only the lipophilic polymer and the amphiphilic polymer are not used, but polymerizable polyfunctional monomer is composed. Then a composition is obtained and used for forming the honeycomb film. Thereafter a curling processing may be made to the honeycomb film by an already known method, such as thermal curing, UV curing, electron radiation curing and the like.

The polyfunctional monomer to be used with the lipophilic polymer and the amphiphilic polymer is preferably polyfunctional methacrylate, in view of the reactivity. As the polyfunctional methacrylate, there are dipentaerythrytol pentaacrylate, dipentaerythrytol hexaacrylate, dipentaerythrytol caprolactone adduct hexaacrylate, denaturated compound of them, and the like. Further, there are epoxyacrylate oligomer, polyester acrylate oligomer, urethaneacrylate oligomer, N-vinyl-2-pyrolidon, tripropylene glycole diacrylate, polyethylene glycole diacrylate, trimethylolpropane triacrylate, pentaerythrithol triacrylate, pentaerythrithol tetraacrylate, modified compound thereof and the like. In view of balance between abrasion resistance and flexibility, single one or a combination of two or more sorts of the above polyfunctional monomers is used. If the cross-linking polymer, in which the lipophilic polymer and the amphiphilic polymer are polymerizable (cross-linkable) compounds having the polymerizable group, is used, it is preferable to use together the polimerizable polyfunctional monomer which is reactive with the polymerizable group.

The polymerization of monomer having ethylenic unsaturated group can be made by heating or radiation of ionization radiation under the existence of photoradical initiator or thermoradical initiator. Therefore, for example, a polymer solution is prepared so as to contain, for example, photoradical initiator, thermoradical initiator, matting particles inorganic filler, and monomer having ethylenic unsaturated group, and then applied on a transparent support or web to form the wet layer 20. Thereafter, the wet layer 20 on the web 12 is cured by the polymerization with application of ionization radiation or thermal energy, such that the antireflective film may be obtained.

As the photoradical polymerization initiator, there are, for example, acetophenones, benzoins, benzophenons, phosphine oxides, ketals, anthraquinones, thioxanthones, azo compounds, peroxides, 2,3-alkyldione compounds, disulfide compound, fluoroamine compounds, and aromatic sulfoniums.

The acetophenons are, for example, 2,2-ethoxyacetophenone, p-methylacetophenone, 1-hydroxydimethylphenylketone, 1-hydroxycyclohexylphenylketone, 2-methyl-4-methylthio-2-morpholino propiophenone, 2-benzyl-2-dimethylamino-1-(4-morpholinophenyl)-butanone and the like.

The benzoins are, for example, benzoin benzenesulfonic acid esters, benzoin toluenesulfonic acid esters, benzoin methylethers, benzoin ethylethers, benzoin isopropyl ethers, and the like.

The benzophenones are, for example, benzophenone, 2,4-chlorobenzophenone, 4,4-dichlorobenzophenone, p-chlorobenzophenone and the like. The phosphine oxides are, for example, 2,4,6-trimethylbenzoyl diphenylphosphine oxide and the like.

Several examples of the photoradical polymerization initiator are described in Saishin UV Kouka-Gijutsu (UV-curing technology, new edition, technical information institute co., ltd., 1991). Further, preferable examples of the photoradical initiator of photocleavage type in the market is irgacure (651, 184, 907) of Ciba Speciality Chemicals. In this embodiment, the quantity of photoradicai polymerization initiator to 100 pts.mass of the polyfuncional monomer is preferably in the range of 0.1 pts.mass to 15 pts.mass, and especially 1 pts.mass to 10 pts.mass. In addition to the photoradical initiator, photosensitizer may be used. The photosensitizers are, for example, n-butylamine, triethylamine, tri-n-butylphosphine, michlar ketone, tioxyantone, and the like.

The thermoradical initiator is, for example, organic peroxides, inorganic peroxides, organic azo compounds, organic diazo compounds, and the like. The organic peroxides are, for example, benzoyl peroxide, halogenbenzoyl peroxide, lauroyl peroxide, acetyl peroxide, dibutyl peroxide, cumene hydroxyperoxide, butylhydroxyperoxide, and the like. The inorganic peroxides are, for example, hydroperoxide, ammonium persulfate, potassium persulfate, and the like. The azo compounds are, for example, 2,2′-azobis(isobutyronitorile), 2,2′-azobis(propionitorile), 1,1′-azobis(cyclohexane carbonitrile) and the like. The diazo compounds are, for example, diazo aminobenzene, p-nitrobenzene diazonium and the like.

The solvent for preparing the polymer solution by dissolving the polymer are, for example, dichloromethane, carbon tetrachloride, cyclorhexane, methyl acetate, and the like. However, the compounds are not restricted especially, so far as the polymer can be dissolved to them. Further, the polymer concentration at the applying may be not restricted, so far as the wet layer 20 can be formed. Concretely, the polymer concentration is in the range of 0.1 wt. % to 30 wt. %. If the polymer concentration is less than 0.1 wt. %, the productivity is too low and therefore it is not adequate for the mass production. If the polymer concentration is more than 30 wt. %, the solvent evaporates and thus the wet layer 20 is dried, before the completion of the enough growing of the water droplets. Therefore, in this case, it is hard to produce the honeycomb film which has a preferable pore size.

As shown in FIG. 2, a polymer solution feeding device 13 is connected to a film production line 10, in which the web 12 as a film base having enough strength is unwound. The web 12 supports the honeycomb layer 8 and increases the strength of the honeycomb film 3. The web 8 is fed out from a web roll chamber 11, and then a polymer solution 15 is continuously fed out from the polymer solution feeding device 13 to a slide coater 14 in the film production line 10. The polymer solution 15 is applied onto (or coated over) the web 12 by the slide coater 14, such that the wet layer 20 may be formed.

A running direction of the web 12, after the formation of the wet layer 20, is inclined at an angle in ±10° to a horizontal direction. In order to make the pitch between the pores shorter and the pore size on the honeycomb film 3 smaller, the web 12 is preferably produced from materials which easily absorb the organic solvent of the polymer solution 15. The materials are not restricted especially, so far as they have the absorbability of the organic solvent. For example, when the methyl acetate is used as a main solvent of the polymer solution 15, it is preferable to use the cellulose acylate as the material for the film.

In this embodiment, it is to be noted that the preferable material for the web 12 is the conductive material, for example, a resin containing filler which is composed of silver, carbon, cupper, nickel and the like.

The polymer solution supplying device 13 has a tank 21 for containing the polymer solution 15, a pump 24 for feeding the polymer solution 15 to the slide coater 14, and first and second filtration devices 26, 27 for filtrating the polymer solution 15. The tank 21 includes a stirrer 22 having blades, and the polymer solution 15 is stirred constantly by rotating the blades. The pump 24 is driven to feed out the polymer solution 15 from the tank 21.

Then the filtration of the polymer solution 15 is made by the first and second filtration devices 26, 27, such that the foreign materials may not be contained in the produced film. If it is designated to use the plurality of the first and second filtration devices 26, 27 as in this embodiment, the first filtration device 26 preferably includes a filter whose absolute filtration accuracy (absolute normal diameter) is larger than a porous diameter of the honeycomb film, and the second filtration device 27 preferably includes a filter whose absolute filtration accuracy is smaller than a porous diameter of the honeycomb film.

In the first filtration device 26, the gel-like foreign materials are trapped from the polymer solution 15 for a long time, and in the second filtration device 27, the foreign materials of the smaller size, the aggregated material and the impurities are trapped.

If it is designated to use only one filtration device, the porous diameter of the filter in the filtration device must be smaller so as to trap also the smaller foreign materials. However, in this case, the life of the filter becomes shorter and the filter must be often changed. Therefore, as in this embodiment, the filtration is made at first by the first filtration device 26 with use of the filter whose porous diameter is large, and then the filtration is made by the second filtration device 27 with use of the filter whose porous diameter is small. Thus the life of the filter of the small porous diameter becomes longer.

Further, as described above, since the absolute normal diameter is determined on the basis of the porous diameter of the honeycomb film, the foreign materials which prevents the formation of the regular structure in the honeycomb film are trapped. Thus the uniform pores are arranged regularly in the produced honeycomb film 3. Note that the solvent to be mixed with the polymer is previously filtrated by the same filtration device as the first and second filtration devices 26, 27.

The web 12 is lapped on a back-up roller 31 and conveyed to the slide coater 14 in accordance with the rotation of the back-up roller 31. The slide coater 14 is provided with a decompression chamber 33, and the decompression degree of the decompression chamber 33 is controlled, such that the applying of the polymer solution 15 onto the web 12 may be uniformly made by the slide coater 14. Thus the thickness control is made at high accuracy and the formation of the wet layer 20 is made at high speed. Therefore, the wet layer forming process is performed at high productivity. Further, the contact of the web 12 on the back-up roller 31 makes the surface of the web 12 smooth. Therefore, even if the surface of the web 12 is not smooth or uneven, the web 12 is excellent for the uniform application of the polymer solution 15 thereon. Furthermore, when the applying is made, the slide coater 14 doesn't contact to the web 12. Therefore the surface of the web 12 is not damaged, and the uniform application of the polymer solution 15 is made. It is to be noted in this embodiment, the wet layer 20 is firmly adhered to the web 12.

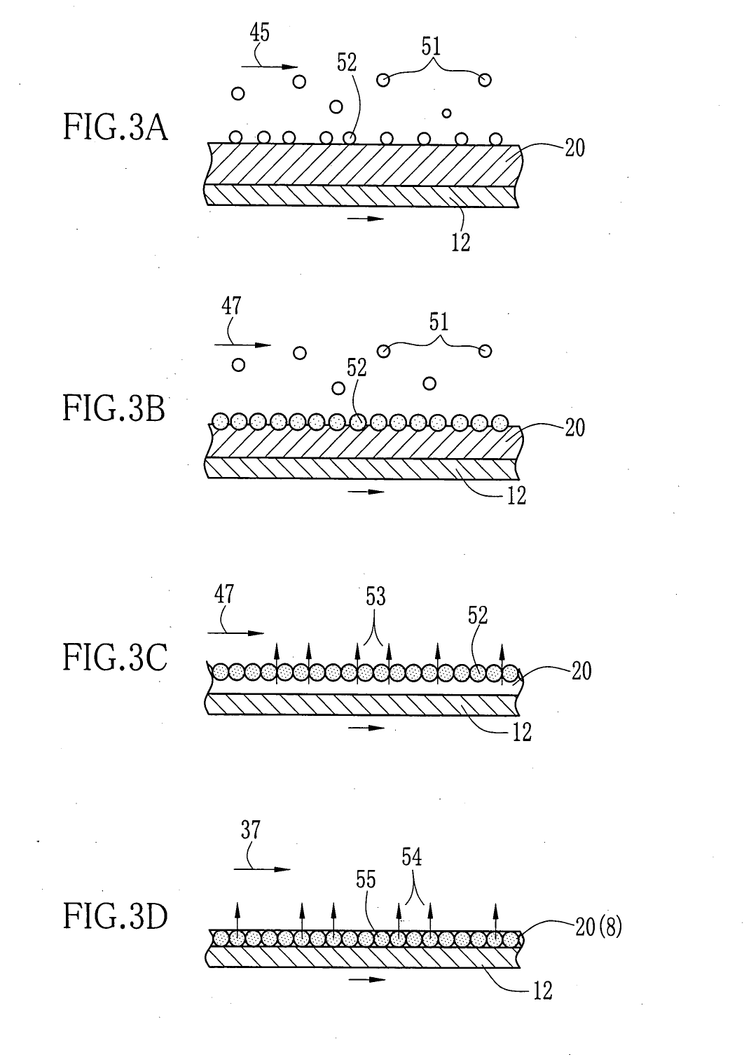

When the wet layer 20 is formed on the web 12, the dewing and the drying of the wet layer 20 are performed. The explanations of the dewing and the drying are made in reference with FIGS. 2 & 3A-3D. In FIG. 3A, the surface temperature TL of the wet layer 20 is preferably at least 0° C. If the surface temperature TL is less than 0° C., the dews in the wet layer 20 are solidified, and therefore the pore of the predetermined size is hardly formed.

In a solution applying chamber 40 in which the bedewing and the drying are performed. The solution applying chamber 40 is partitioned into a bedewing area 41 for generating and growing the water droplets on the wet layer 20 and a drying area 42 for evaporating the water droplets and solvent. When the evaporation is made in the drying area 42, a plurality of pores is formed in the wet layer 20. While the wet layer 20 on the web 12 is fed through the bedewing area 41 and the drying area 42, the wet layer 20 becomes a honeycomb layer (porous layer) 8. The bedewing area 41 is provided with an air feeding/aspirating device 44 for feeding an air blow 45 to the wet layer 20 on the web 12 and aspirating the air blow 45. The air feeding/aspirating device 44 includes an air feeding controller (not shown) for controlling the conditions of the air blow 45, concretely the temperature, the moisture, a volume and an aspiration force of the air blow 45 independently. When the feeding conditions of the air blow 45 are controlled, the generation and the growth of the water droplet are controlled. The growth of the water droplet means that the water droplet becomes larger, the size of the water droplet becomes uniform, the water droplet is formed minutely, and the number of the water droplet becomes larger, independent from the variation of the size of the water droplet. The air feeding/aspirating device 44 controls the temperature and the dew point of the air blow 45, and has a plurality of air feeding/aspirating units 201-203 for feeding and aspirating the air blow 45. The air feeding/aspirating units 201-203 are continuously arranged in the running direction of the web 12. The air feeding/aspirating unit 201 has the outlet 201a and the inlet 201b, the air feeding/aspirating unit 202 has an outlet 202a and an inlet 202b, and the air feeding/aspirating unit 203 has an outlet 203a and an inlet 203b. The air blow 45 is fed out from the outlet 201a and aspirated through the inlet 201b, the airblow 45 is fed out from the outlet 202a and aspirated through the inlet 202b, and the air blow 45 is fed out from the outlet 203a and aspirated through the inlet 203b. Thus the bedewing conditions are adjusted in the running direction of the wet layer, and therefore the growth of the water droplet is easily controlled. Further,

Note that each of the outlets 201a, 202a, 203a and the inlets 201b, 202b, 203b is provided with a filter for keeping a dust level, namely a cleaning level. Further, the air feeding controller preferably controls the conditions of the air blow 45 in the air feeding/aspirating units 201-203 independently. Further, each of the inlet and outlet may be partitioned into plural partitions which are to be arranged in a widthwise direction of the web 12, such that the conditions for feeding and the aspirating may be controlled independently in each partition. Thus the bedewing conditions are also controlled in the widthwise direction. Note that the air feeding/aspirating units 201-203 are provided in the air feeding/aspirating device 44. However, the number and the structure of the air feeding/aspirating units are not restricted in this figure.

The drying area 42 is provided with a drying device 46, which feeds a drying air 47 to the wet layer 20 and aspirates the drying air 47. The drying device 46 is also an air feeding device similar to the feeding/aspirating device 44, and therefore controls the temperature and the dew point of the drying air 47. The drying device 46 a plurality of air feeding/aspirating units 206-208 which are arranged in the running direction of the wet layer 20. The air feeding/aspirating unit 206 has an outlet 206a and an inlet 206b, the air feeding/aspirating unit 207 has an outlet 207a and an inlet 207b, and the air feeding/aspirating unit 208 has an outlet 208a and an inlet 208b. Thus the drying conditions for the wet layer 20 are easily adjusted.

When the wet layer 20 enters into the drying area 42, the growth of the water droplet is end. Then the evaporation of the organic solvent is made at first, and thereafter that of the water droplet follows. Therefore, under the same temperature and the same pressure, the evaporation speed of the organic solvent is preferably higher than the water droplet such that the organic solvent may evaporate faster than the water droplet. However, even if the evaporation speed of the organic solvent and the water droplet is the same, the order of the evaporation can be the same. In this case, however, it is preferable that the water droplet has a larger affinity to the polymer than the organic solvent or the organic solvent has a lower intermolecular force (van der Waals' force) than the water droplet. Thus the evaporation of the organic solvent is made at first, and then that of the water droplet follows.

In this embodiment, since the order of the evaporation is controlled as described above, the water droplet more easily penetrates into the wet layer 20 during the evaporation of the organic solvent. Preferably, the evaporation of the water droplet starts after the end of the evaporation of the organic solvent. However, present invention is not restricted in it. The evaporation of the water droplet may start when around 0.1 to 30% of the organic solvent in the wet layer 20 is evaporated.

In this figure (FIG. 2), the drying device 46 has the four feeding/aspirating units 206-209. However, the number of the air feeding/aspirating unit is not restricted in it. The drying device 46 includes an air feeding controller (not shown) for independently controlling the temperature, the moisture, a volume and an aspiration force of the drying air 47. According to the drying device 46, instead of that the air feeding/aspirating device 44 has the air feeding/aspirating units 201-203, the number of the air feeding/aspirating unit may be one, which has at least two inlets and at least two outlets. Further, each of the inlet and outlet may be partitioned into plural partitions which are to be arranged in a widthwise direction of the web 12, such that the conditions for feeding and the aspirating may be controlled independently in each partition. Thus the bedewing conditions are also controlled in the widthwise direction.

At least one of the dew point TD1 (0° C.) of the air blow 45 from the air feeding/aspirating device 44 and the surface temperature TL (0° C.) of the wet layer 20 passing through the bedewing area 41 is controlled, such that a condition, 0° C.≦(TD1−TL), may be satisfied. Thus the water droplets are adequately generated from the water vapor in the air blow 45 flowing near the wet layer 20. The condition is preferably 0° C.≦(TD1−TL)≦80° C., particularly 0° C.≦(TD1−TL)≦30° C., and especially 0° C.≦(TD1−TL)≦10° C. If the value of (TD1−TL) is less than 0° C., the bedewing becomes more difficult. If the value of (TD1−TL) is more than 80° C., the bedewing speed, namely the generation speed of the bedewing becomes too large. Therefore the water droplets are contacted to each other, and otherwise a new water droplet is formed on the water droplet already formed. Thus, the pore size of the honeycomb film 3 sometimes becomes nonuniform, and namely the film structure sometimes cannot become uniform. Further, although the temperature of the air blow 45 is not restricted especially, it is preferably in the range of 5° C. to 100° C. If the temperature is more than 100° C., the evaporation of the water droplet is made before it penetrates into the wet layer 20.

The fluctuation of the surface temperature TL just before the entering of the wet layer 20 into the bedewing area 41, and the fluctuations of the dew points near the conveying path just before and just after the bedewing area 41 are preferably in ±3° C.

As shown in FIG. 3A, a moisture 51 in the air blow 45 in the bedewing area 41 bedews on the wet layer 20 to form a water droplet 52. Further, as shown in FIG. 3B, the bedewing of the moisture 51 proceeds such that the water droplet 52 grows. The organic solvent starts evaporating just after the applying, and the evaporating speed is controlled by adjusting the temperature of the web 12 and the atmosphere temperature. While the control is made, the surface temperature TL of the wet layer 20 is controlled to a predetermined value, and then the wet layer 20 is fed into the bedewing area 41. As shown in FIG. 3C, the drying air 47 is fed to the wet layer 20 in the drying area 42, an organic solvent 53 evaporates from the wet layer 20. In the evaporation of the organic solvent 53, although the evaporation of the water droplet 52 also occurs, the organic solvent evaporates faster than the water droplet 52. Therefore, a plurality of water droplets 52 has the almost same form in effect of the surface tension, and the water droplet 52 penetrates into the wet layer 20 in accordance with the evaporation of the organic solvent 53. Note that the water droplet 52 sometimes penetrates into the wet layer 20 with the growth.

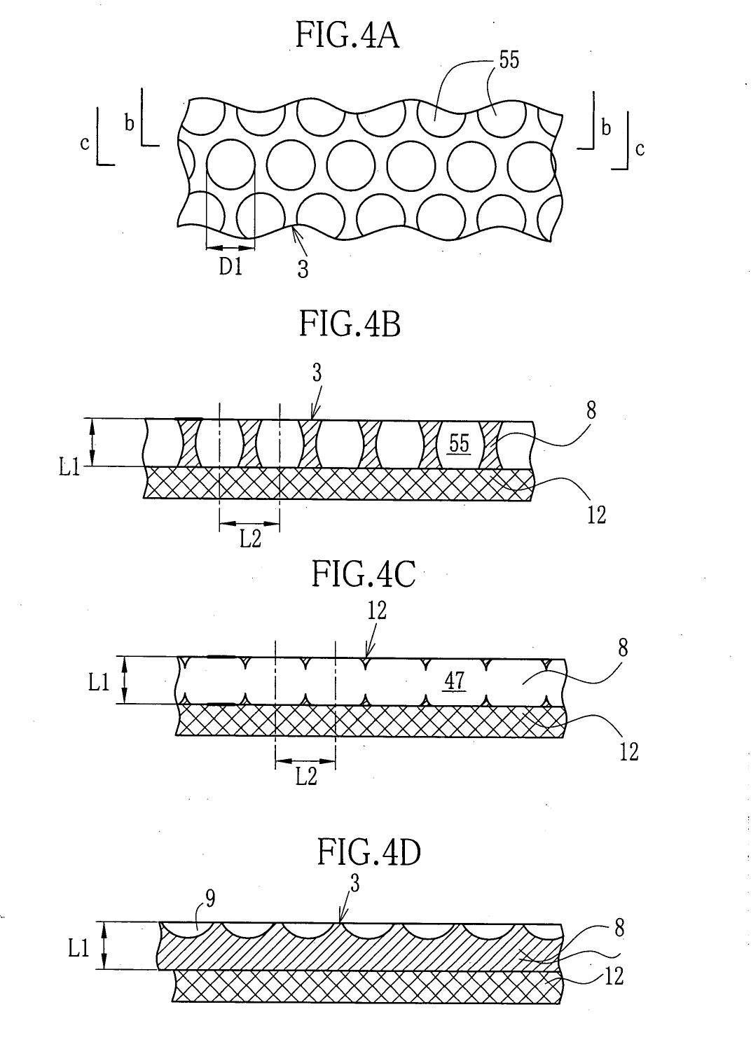

Further, as shown in FIG. 3D, when the drying of the wet layer 20 proceeds, the water droplet 52 evaporates to a water vapor 54. In the evaporation of the water droplet 52, a pore 55 is formed on an area where the water droplet 52 has been disposed. Thus the wet layer 20 becomes a honeycomb layer 8 (see, FIGS. 4A-4D) as a porous film.

As shown in FIG. 4A, the honeycomb layer 8 is formed in the honeycomb film 3, and a plurality of the pores 55 are formed in the honeycomb layer 8. The formation of the pores 55 are controlled in the bedewing process. The bedewing conditions may be controlled such that the water droplet penetrates through the wet layer, and as shown in FIG. 4B, pores 55 are formed in the honeycomb layer 8 on the web 12. In this case, as shown FIG. 4C, the pores 55 may be connected to each other. Otherwise, the bedewing conditions may be controlled such that the water droplet doesn't penetrate into the wet layer so much, and as shown in FIG. 4D, the honeycomb layer 8 has a plurality of recesses 9.

The arrangement of the pore 55 is different depending on the density or the size of the water droplet, the sorts of the formed drops, the drying speed and the like. In the present invention, the structure and the embodiment of the honeycomb film is not restricted especially. However, the present invention is especially effective for producing the honeycomb film in which a distance L2 between the centers of the neighboring pore is in the range of 0.05 μm to 100 μm.

As described above, in the honeycomb film formed in self-organizing effect, a plurality of the pores has the same form and the same size, and is arranged regularly in a direction. The regular arrangement is two-dimensional if the honeycomb film 3 has only single one of the honeycomb layer 8, and three-dimensional if the honeycomb film 3 has a plurality of the honeycomb layers 8. For example, in the two dimensional arrangement of the pores, one pore is surrounded by plural (for example, 6) pores, and in the three dimensional arrangement, the pores are often filled at most in the face-centered cubic structure or the hexagonal structure. However, in some production conditions, the other arrangements are made.

The thickness of the honeycomb layer 8 is preferably in the range of 1 μm to 200 μm. However, if the polymer concentration of the polymer solution is higher, it may be designated that the produced honeycomb film 3 has a three-layer structure. In this case, one of the three layers is the web as the base of the lowermost layer. Among the two layers, the upper layer is a porous layer in which the pores are formed, and the lower layer (or an intermittent layer between the web and the porous layer) is a non-porous layer in which there are no pores. Further, in this case, the thickness of the non-porous layer is preferably in the range of 1 μm to 500 μm.

In the present invention, it is preferable that the air blow 45 is fed out to the wet layer 20 so as to flow in a downstream side of the running direction of the web 12, and the feeding direction is at a predetermined angle with the running direction. In this case, the fluctuation of the air blow 45 is reduced in ±20° from the predetermined angle. Especially preferably, the feeding direction is parallel to the running direction. If the feeding direction of the air blow 45 is opposite to the running direction to the web 12, the speed control of the air blow 45 becomes difficult under the condition of the low relative speed, and therefore the exposure surface of the wet layer 20 cannot be smooth, which sometimes inhibits the growth of the water droplet 52. Further, in this embodiment, the feeding speed of the air blow 45 is controlled. In this case, the relative speed of the feeding speed of the air blow 45 to the transporting speed of the web 12 is preferably in the range of 0.1 m/s to 20 m/s, particularly 0.5 m/s to 15 m/s, and particularly 1 m/s to 10 m/s. If the relative speed is less than 0.1 m/s, the web 12 is transported to the drying area 42 before the water droplets are arranged minutely. If the relative speed is more than 20 m/s, the exposure surface becomes not smooth, and the bedewing cannot proceed enough. The fluctuation of the relative speed is preferably in 20% from an average of the relative speed.

The control of these conditions about the relative speeds increases the effects to form the water droplet 52 uniformly. The control of the relative speed is performed by adjusting at least one of the feeding speed of the air blow 45 and the transporting speed of the web 12.

In the present invention, preferably, it takes 0.1 seconds to 10 seconds for the web 12 with the wet layer 20 to pass the bedewing area 41. Thus many water droplets 52 are generated uniformly and enough for forming the pores fully and minutely. If it takes less than 0.1 seconds, the growth of the water droplet 52 is not made enough, and therefore the pores cannot be formed as designated or the pores cannot be formed in the wet layer fully and minutely. If it takes more than 100 seconds, the water droplet 52 becomes too large, and therefore it becomes hard to produce the honeycomb film 3. Thus since the passing time of the wet layer 20 through the bedewing area 41 is controlled, the size of the pores and the like can be controlled. Further, when it is designated to produce the honeycomb film 3 not continuously but in a batch manner, the time during which the wet layer 20 is disposed under the bedewing condition is controlled, instead of the passing time through the bedewing area 41.

Also according to the drying air 47 for drying the wet layer 20 in the drying area 42, the relative speed of the feeding speed of the drying air 47 to the transporting speed of the web 12 is preferably in the range of 0.1 m/s to 20 m/s, particularly 0.5 m/s to 15 m/s, and particularly 1 m/s to 10 m/s. If the relative speed is less than 0.1 m/s, the evaporation of the water droplets is sometimes not made enough, and therefore the productivity becomes lower. If the relative speed is more than 20 m/s, the evaporation is made suddenly, and therefore the pores are sometimes deformed.

At least one of the dew point TD2 (° C.) of the drying air 47 and the surface temperature TL (° C.) of the wet layer 20 is controlled, such that a condition (TL−TD2)≧1° C. may be satisfied. Thus the growth of the water droplets 52 stops, and it evaporates to the water vapor 54. If the value (TL−TD2) is less than 1° C., the growth of the water droplets cannot be stopped, and therefore the accuracy of the size of the pore 55 sometimes becomes lower. If the value (TL−TD2) is more than 80° C., the water droplets 52 and the organic solvent evaporate suddenly, and the arrangement and the shape of the water droplet 52 change, which makes hard to produce the honeycomb film.

The fluctuations of each of the surface temperature TL just before the drying area 42, the dew point around the transport path just before the drying area 42, and the dew point around the transport path just after the drying area 42 are preferably in ±3° C.

The wet layer 20 is dried by the drying device 46 including 2D (two-dimensional) nozzle, and otherwise, instead of or addition to the method, the wet layer 20 may be dried by a decompression drying method. Thus the evaporation speed of each of the organic solvent 53 and the water droplet 52 can be adjusted, and the evaporation of the organic solvent 53 and the water droplet 52 is made well. Therefore the water droplet 52 can be formed on the wet layer 20 adequately. Consequently, the pore 55 is formed at the position of the water droplet 52 so as to have the designated shape. Note that the 2D nozzle is constructed a discharging branch through which the drying air 47 is fed out and an aspiration branch through which the drying air 47 is aspirated. The 2D nozzle preferably feeds and aspirates the drying air to all over the wet layer 20 uniformly. Further, in this embodiment, the difference of the surface temperature TL of the wet layer 20 to the dew point TD2 of the drying air 47 is at most 80° C. Thus the rapid evaporation of the organic solvent or the water droplet is reduced, and therefore the honeycomb film 3 can be produced.

Further, at a position 3 mm to 20 mm apart from the surface of the wet layer 20, a condenser whose surface has grooves and is cooled may be disposed for condensing the water vapor and the solvent vapor. Thus the humidity and the density of the solvent vapor near the surface of the wet layer 20 is controlled, not so as to be too high in the drying.

One of the above drying methods can be applied to the present invention. Thus the damage of the surface of the wet layer 20 is reduced, and therefore the surface becomes smooth.

Further, the number of the air feeding/aspirating device 44 and the air feeding/aspirating units can be changed, and otherwise the insides of the air feeding/aspirating device 44 and the drying device 46 may be partitioned to plural partitions. Thus the bedewing conditions and the drying conditions can be adjusted in each unit and each partition. In this case, the control of the size of the pore 55 can be made more adequately, and the formed pore 55 becomes more uniformly. Note that the number of the air feeding/aspirating device 44 and the air feeding/aspirating units is not restricted especially. However, it is determined adequately, in view of the quality of the film and the cost of the equipment.

If containing the impurities, the wet layer 20 hardy becomes to the honeycomb layer 8. Therefore, the dust level of the outlets 201a, 202a, 203a, 206a, 207a, 208a, 209a is preferably at most 1000. Therefore, each unit in the air feeding/aspirating device 44 and the drying device 46 includes a filter (not shown) for removing the dusts and the like from an air feeding system, so as to make the air conditioning in a housing. Thus the impurities in the honeycomb layer 8 are reduced, and the produced honeycomb film 3 has a high quality.

A viscosity of the wet layer 20 is described as N1, and that of the water droplet is as N2. A condition N1<N2 is preferably satisfied, after the formation of the bedewing starts in the bedewing area 41 and before the adequate formation of the water droplet becomes stable. Thus the water droplet 52 penetrates into the wet layer 20 such that the pores are uniformly formed in the honeycomb film 3. In order to satisfy the above condition, the polymer solution 15 is prepared so as to have a low viscosity. In this case, the condition N1<N2 is sometimes satisfied only at first. Thereafter, however, before the pores are formed adequately, the value N1 becomes larger than the value N2 during cooling in the bedewing area 41 and drying in the drying area 42. Therefore, a control is necessary, for example the temperature is made higher once, such that the value N1 becomes smaller than the value N2 even temporarily. Note that the viscosity control may be performed not only once but also several times.

The honeycomb film 3 whose drying has proceeded is continuously wound up around a winding shaft 32. The transporting speed of the honeycomb film 3 is not restricted especially, but preferably in the range of 0.1 m/min to 60 m/min. If the transporting speed is less than 0.1 m/min, the productivity doesn't become high, which is not preferable in view of the cost. If the transporting speed is more than 60 m/min, the tension is excessively applied to the honeycomb film 3 to tear it, or the honeycomb structure becomes disordered.

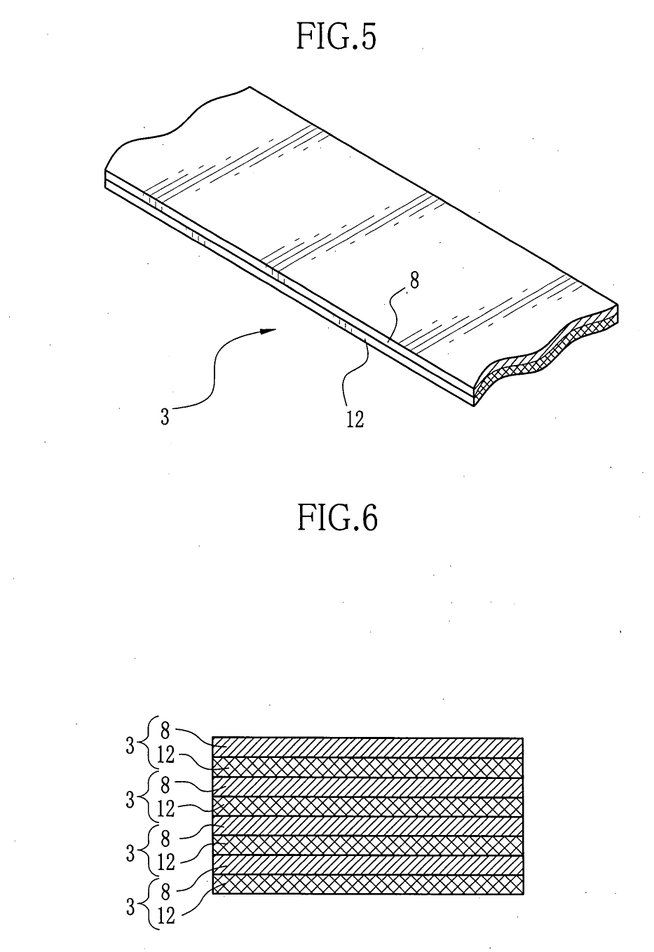

In FIG. 5, the honeycomb layer 8 covers almost over the web 12 in the widthwise direction. Thus the reinforcement for all over the honeycomb layer 8 is made by the web 12. Therefore, as shown in FIG. 6, when the honeycomb film 3 is piled up, it is hardly damaged and torn. Furthermore, the conductive material is used as the web 12, the generation of the static charge is prevented. Therefore, the foreign material doesn't adsorb to the honeycomb film 3. Thus the pollution and the damage of the honeycomb film 3 are prevented.

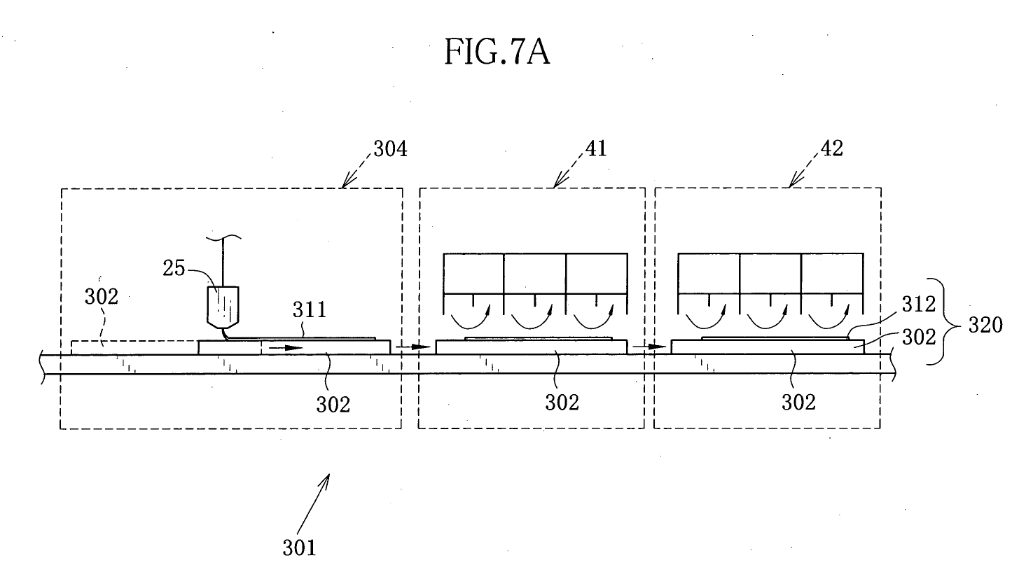

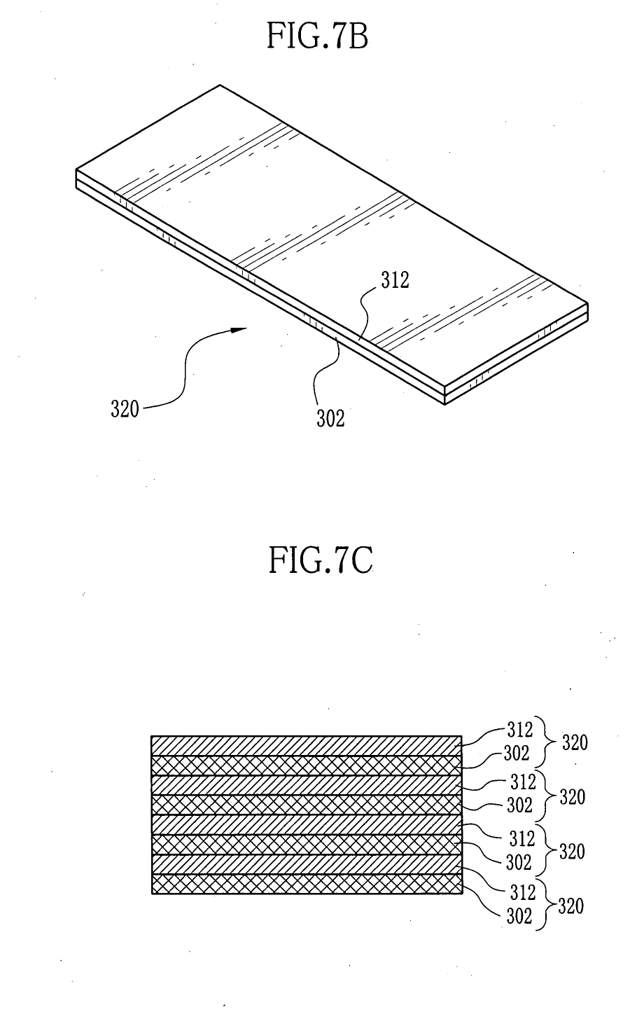

In this embodiment, the applying of the polymer solution 15 is made continuously in the production of the honeycomb film 3. However, the present invention is not restricted in it. For example, the applying of polymer solution may be intermittently made, such that the incontinuous type of the honeycomb film may be produced one by one. In FIG. 7A, a film production line 301 has a solution applying area 304 for applying the polymer solution onto a film base (hereinafter, base) 302, the bedewing area 41 and the drying area 42. In the solution applying area 304, the polymer solution is applied or cast from a casting die 25 onto the base 302, so as to form a wet layer 311, and the base 302 is fed to the bedewing area 41. After the generation of the water droplets on the wet layer 311 in the bedewing area 41, the base 302 is transported into the drying area 42. In this embodiment, the treatment in each process is made for each base 302, and the bases 302 are transported one by one. In this case, the time during which the wet layer 311 is disposed under the bedewing condition in the bedewing area 41 is controlled. Thus the wet layer 311 becomes a honeycomb film 312, such that a honeycomb film 320 may be produced. Note that the same numbers are applied to the same members and devices, and the explanations thereof are omitted.

In FIG. 7B, the honeycomb layer 312 and the base 302 are formed to have the same size of the surface. Thus the reinforcement is made all over the honeycomb layer 312. Therefore, as shown in FIG. 7C, when the honeycomb film 320 is piled up, it is hardly damaged and torn. Furthermore, the conductive material is used as the base 302, the generation of the static charge is prevented. Therefore, the foreign material doesn't adsorb to the honeycomb film 320. Thus the pollution and the damage of the honeycomb film 320 is prevented.

In order to produce the honeycomb film 320 of the incontinuous type (sheet type), it is preferable to use a plurality of dies whose width is shorter that the casting die 25. The plural dies are arranged at a predetermined interval in the widthwise direction of the base 302, and apply the solutions onto the base 302 at short time cycle, so as to form a plurality of the wet layers 311 of the smaller size. Further, a die lip of the die may be partitioned to several parts in the widthwise direction. In this case, the polymer solution 15 is intermittently applied so as to produce the honeycomb film strip.

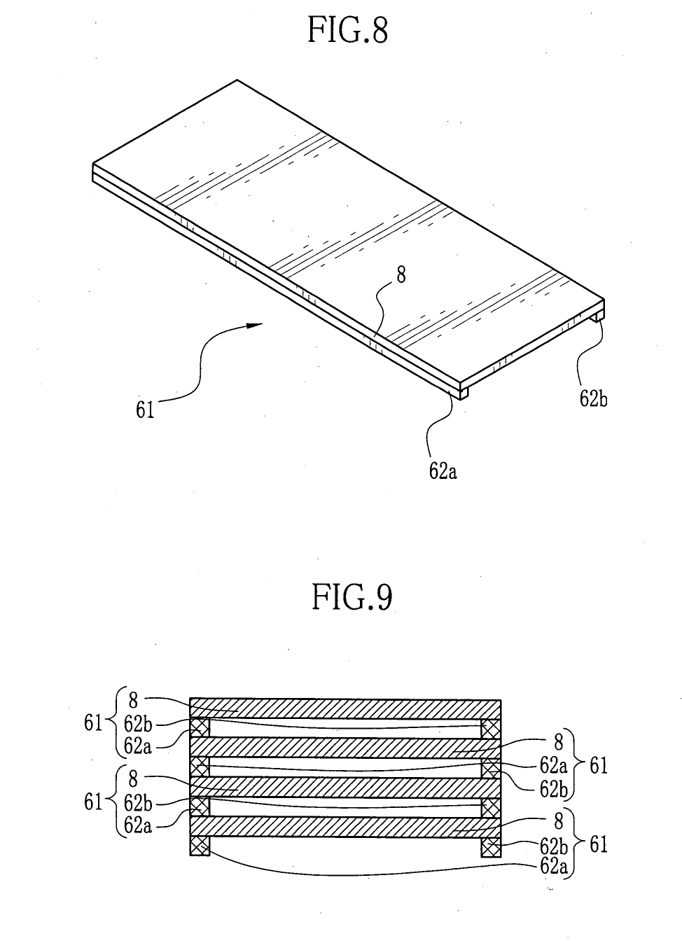

The embodiment of the honeycomb film is not restricted in the above explanation. In FIG. 8, a honeycomb film 61 includes the honeycomb layer 8 and film bases (hereinafter, bases) 62a, 62b supporting edge portions of the honeycomb layer 8. In order to produce the film bases 62a, 62b of this embodiment, at first a sheet type film or a strip type film is formed similarly to the honeycomb film 320 in FIGS. 7B & 7C, and then a part of the web 12 between the edge portions is slit off. Note that the honeycomb film 3 in FIG. 5 may be slit such that a plurality of the sheet type film or the strip type film may be obtained, and then a part of the base between the edge portions may be slit off. Thus the honeycomb film 61 is obtained, in which the side edge portions of the honeycomb layer 8 is supported.

The honeycomb film 61 is piled as in FIG. 9, and otherwise wound up if it is the continuous type. In both cases, only the side edges of the honeycomb layer 8 contacts to the bases 62a, 62b. Therefore the force to be applied to the honeycomb layer 8 is small, especially in a middle portion of the honeycomb layer 8 that doesn't contact to the bases 62a, 62b. Therefore, the damage and the tear of the honeycomb film 61 are prevented.

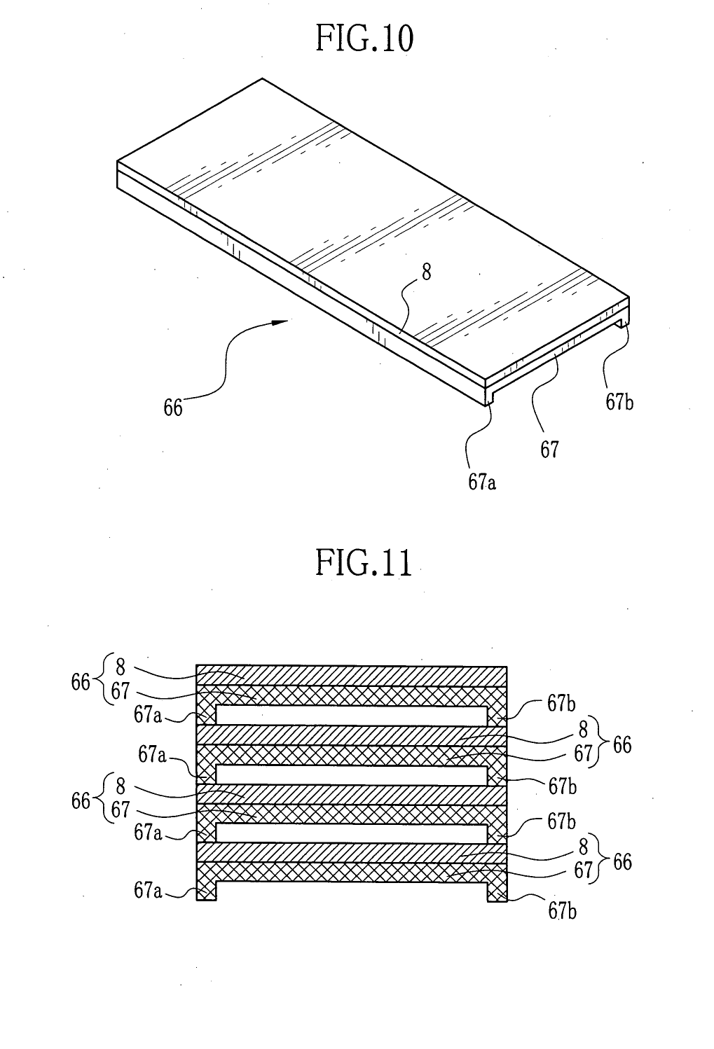

Further, in FIG. 10, a honeycomb film 66 has the honeycomb layer 8 and abase 67, and thus the reinforcement of the honeycomb layer 8 is made. The base 67 has thick parts 67a, 67b in both side edges. The thick parts 67a, 67b are protruded in an opposite side to a side of the honeycomb layer 8. The honeycomb film 66 is piled up as shown in FIG. 11, and otherwise wound up if it is the continuous type. In both cases, the side edges of the honeycomb layer 8 contact to the thick parts 67a, 67b. Therefore, the force and tension applied to the honeycomb layer 8 is not so large, and therefore the damage and the tear of the honeycomb film 66 are prevented.

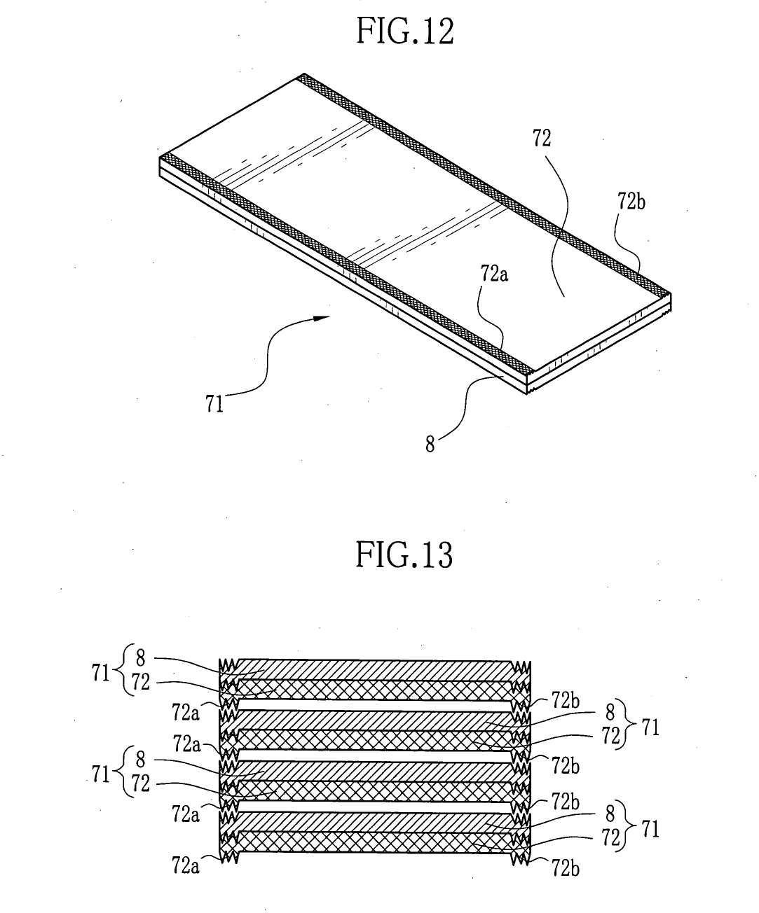

In FIG. 12, a honeycomb film 71 has the honeycomb layer 8 and a base 72. A bottom of the base 72 has asperities 72a, 72b in both side edges. In each asperity 72a, 72b are formed uncountable sharp-corrugated-portions. The asperities 72a, 72b are formed by a knurling process, namely by pressing on the base 72 a roller having a net-like knurling. The honeycomb film 71 is piled up as shown in FIG. 13, but otherwise wound up if it is the continuous type. In both cases, since the reinforcement of the honeycomb layer 8 is entirely made, the force applied to the honeycomb layer 8 (especially to a middle portion of the honeycomb layer 8) is not so large. Thus the damage and the tear of the honeycomb film 71 are prevented.

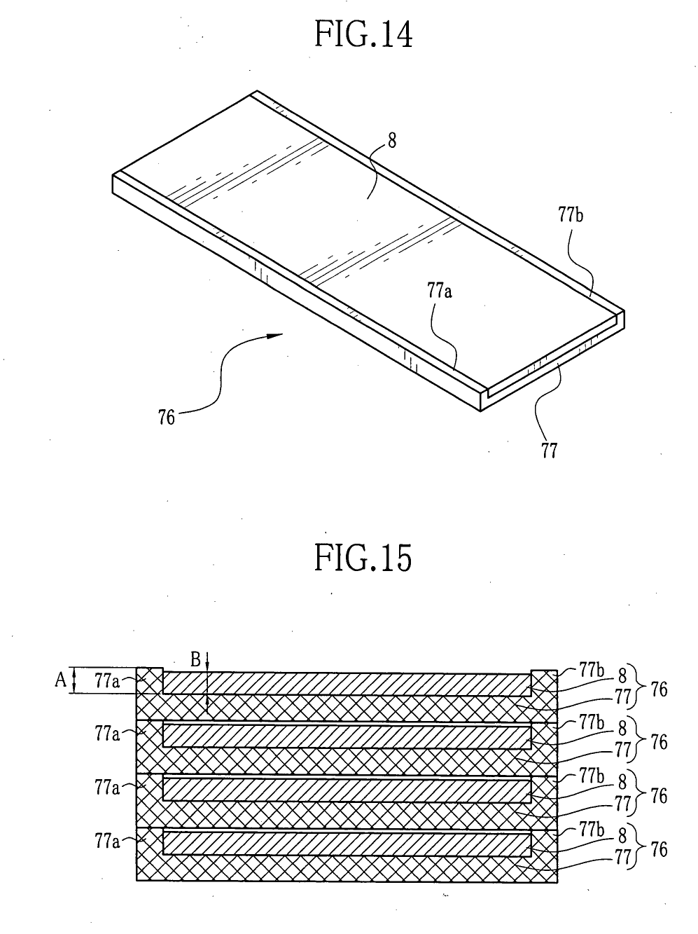

Further, in FIG. 14, a honeycomb film 76 has the honeycomb layer 8 and a base 77. The base 77 has protrusions 77a, 77b in both side edges. The protrusions 77a, 77b are protruded to a side of the honeycomb layer 8, so as to be disposed on side edges of the honeycomb layer 8. Therefore, the honeycomb layer 8 is disposed between the protrusions 77a, 77b. Further, as shown in FIG. 15, a height A of each protrusion 77a, 77b is larger than the thickness B of the honeycomb layer 8. For storage, the honeycomb film 76 is piled up, and otherwise wound up if it is the continuous type. In both cases, the protrusions 77a, 77b contact to each other, the reinforcement of the honeycomb layer 8 is entirely made. Thus the force and tension applied to the honeycomb layer 8 is not so large. Consequently the damage and the tear of the honeycomb film 76 are prevented.

In these embodiments, while the bases for the reinforcement and support of the honeycomb film are used, the honeycomb film is firmly adhered to the base. However, the present invention is not restricted in them. For example, the base of the honeycomb layer may be as a peelable and temporary-used base, and the temporary-used base is peeled from the honeycomb film in the following processes. For example, all of the bases in FIGS. 5-14 may be the temporary-used bases such that the honeycomb films are peeled from them. Thus the single layer film without the base is formed. Further, in each case, it is preferable to previously form a releasing layer on the contact surface of the temporary-used base to the honeycomb film, such that the honeycomb film is easily peeled from the temporary-used base. Preferably the releasing layer includes a release agent at least, and other materials if necessary. As the release agent, for example, there are silicone resin of emulsion type, solvent type or non-solvent type, fluorine resin, aminoalkyl resin, polyester resin, polyester resin, wax and the like, and a single one or at least two sorts thereof may be used. Further, not only the release agent but also several sorts of additives may be added.

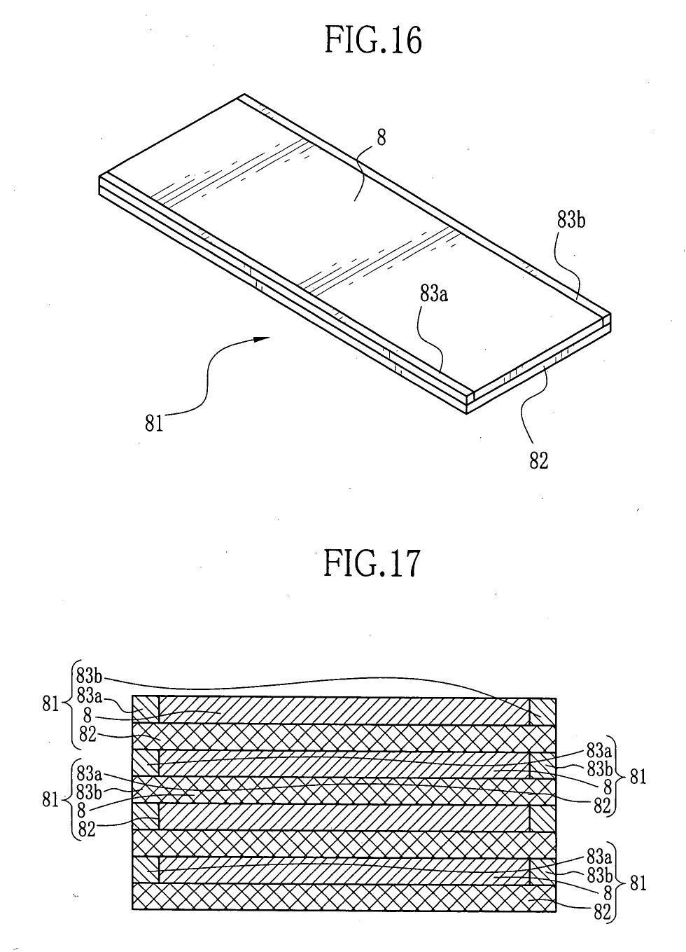

After the honeycomb layers are peeled from the temporary-used bases, the honeycomb film is easily damaged and torn. Therefore, as shown in FIG. 16, a honeycomb film 81 includes the honeycomb layer 8, a temporary-used base 82, and two lasting bases 83a, 83b. The lasting bases 83a, 83b are disposed on the edge of the honeycomb layer 8, the honeycomb layer 8 is disposed between the lasting bases 83a, 83b. In this embodiment, the temporary-used base 82 is peelable from the honeycomb layer 8 and the lasting bases 83a, 83b. In order to make the peeling easily, the honeycomb film 81 has a releasing layer (not shown) between the temporary-used base 82 and the honeycomb layer 8 and between the temporary-used base 82 and the lasting bases 83a, 83b. In the production of the honeycomb film 81, the polymer solution is applied between the lasting bases 83a, 83b on the temporary-used base 82 to form the wet layer which is to be the honeycomb layer 8. The honeycomb film 81 is piled up as shown in FIG. 17, and otherwise wound up if it is the continuous type. In both cases, the reinforcement is made over the honeycomb layer 8 by the lasting bases 83a, 83b, and especially on the side edge portions of the honeycomb layer 8 by the lasting bases 83a, 83b. Therefore, the force applied to the honeycomb layer 8 is not so large. Consequently the damage and the tear of the honeycomb film 81 are prevented. Furthermore, since the lasting bases 83a, 83b also support the honeycomb layer 8 after the peeling of the temporary-used base 82, the damage and the tear of the honeycomb layer 8 are prevented.

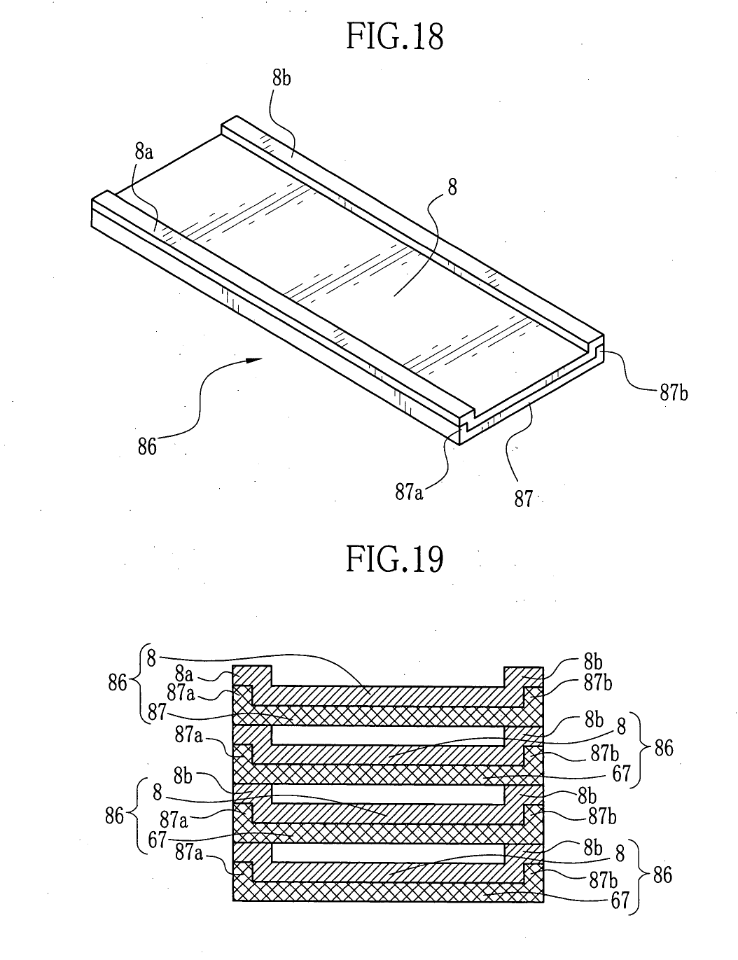

Note that the present invention is not restricted in the above embodiments. In FIG. 18, a honeycomb film 86 includes the honeycomb layer 8 having both side bumps 8a, 8b, and a temporary-used base 87 having two protrusions 87a, 87b in both side edge portions. The protrusions 87a, 87b protrude to a side of the honeycomb layer 8. The honeycomb layer 8 is formed so as to entirely cover the temporary-used base 87. Therefore, the side bumps 8a, 8b are respectively disposed on the protrusions 87a, 87b. The honeycomb film 86 is piled up as shown in FIG. 19, and otherwise wound up if it is the continuous type. In both cases, thus the entire of the honeycomb layer 8, especially both side bumps 8a, 8b are supported. Therefore, the damage and the tear of the honeycomb film 86 are prevented, especially in the middle portion of the honeycomb layer 8.

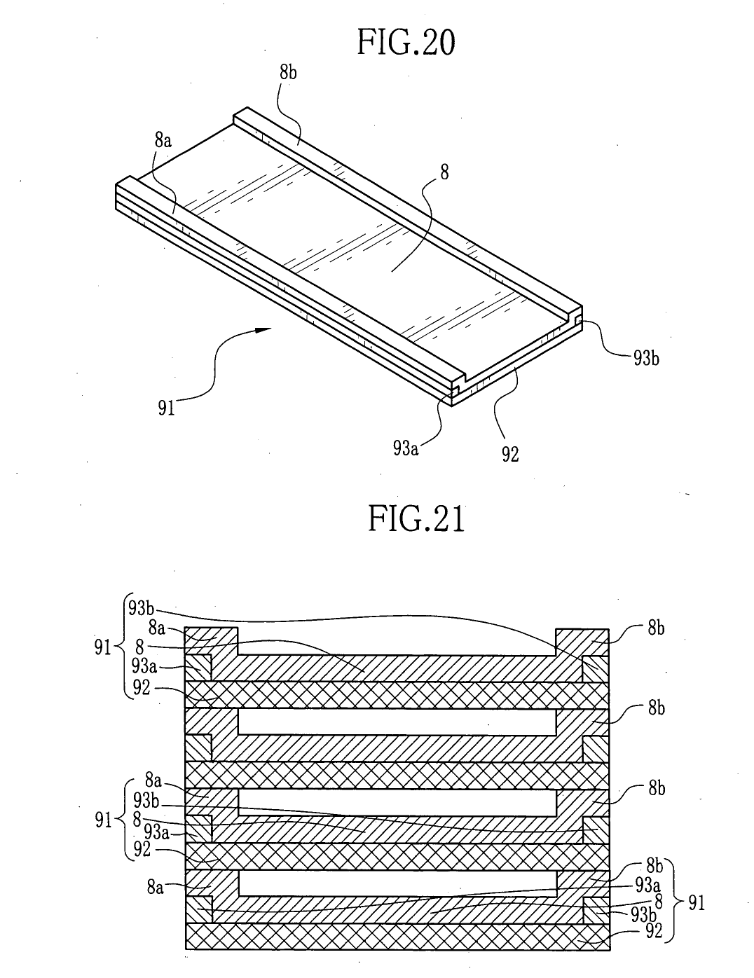

In FIG. 20, a honeycomb film 91 includes the honeycomb layer 8, a temporary-used base 92, and two lasting bases 93a, 93b. In this embodiment, the shapes and the positions of the temporary-used base 92 and the lasting bases 93a, 93b are the same as the temporary-used base 82 and the lasting bases 83a, 83b. In this embodiment, however, the honeycomb layer 8 is also formed on the lasting bases 93a, 93b. Therefore the honeycomb layer 8 has the side bumps 8a, 8b on the lasting bases 93a, 93b. The honeycomb film 91 is piled up as shown in FIG. 21, and otherwise wound up if it is the continuous type. In both cases, thus the entire of the honeycomb layer 8, especially the side bumps 8a, 8b are supported. Therefore, the force and tension applied to the honeycomb layer 8 is not so large. Consequently the damage and the tear of the honeycomb film 91 are prevented. Furthermore, since the lasting bases 93a, 93b also support the honeycomb layer 8 even after the peeling of the temporary-used base 92, the damage and the tear of the honeycomb layer 8 are prevented.

Further, in the above embodiments of the honeycomb films, the position of the temporary-used base doesn't depend on the usable area in the product size or the usable area of the honeycomb film. As shown in FIG. 22, a honeycomb film 96 includes the honeycomb layer 8 and bases 98a, 98b provided on a bottom of the honeycomb layer 8. In the honeycomb layer 8 there is a usable area 97. Note that the usable area 97 is an area between double dotted lines. The bases 98a, 98b are disposed in outsides of the usable area 97. Thus this embodiment has the same effects as the above embodiments, and when the honeycomb film 96 is used as the film products, the honeycomb film 8 has original properties without influences of the bases 98a, 98b.

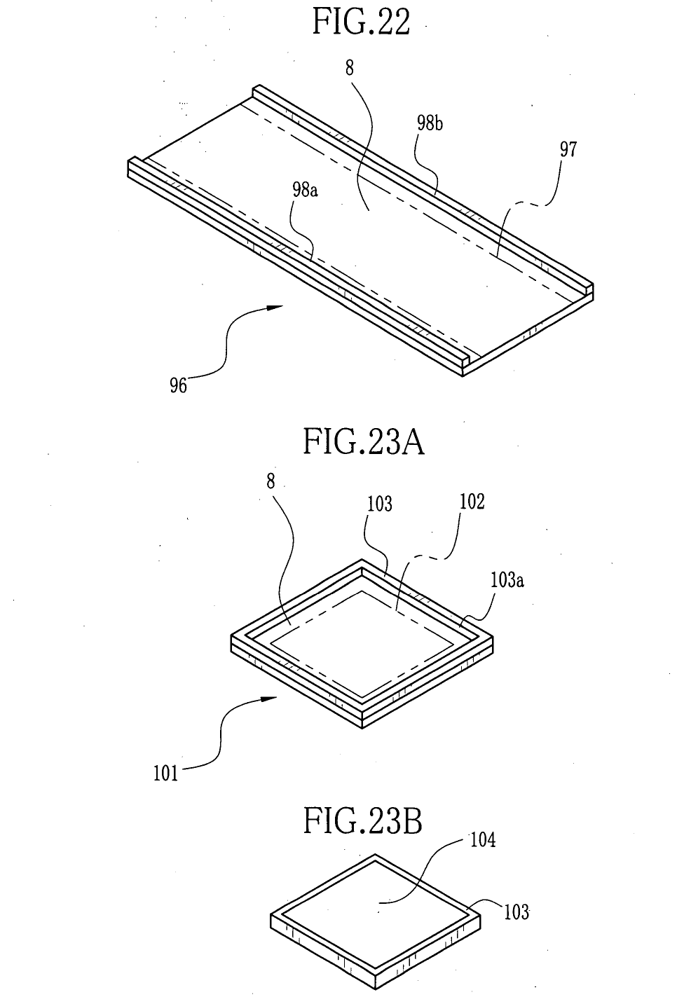

In FIG. 23A, a honeycomb film 101 has the honeycomb layer 8 and a base 103 as a square frame. The base 103 ha an opening 103a in which there is a usable area 102 of the honeycomb layer 8. Therefore the base 103 is disposed in outside of the usable area 102. In order to produce the honeycomb film 101, as shown FIG. 23B, a base 104 may be previously fitted in the base 103. In this case, the wet layer is formed on the bases 103, 104, and the base 104 is peeled after the honeycomb layer 8 is formed. Otherwise, the wet layer may be formed on a square base (not shown), and after the honeycomb layer 8 is formed, the middle portion of the square base is slit off, such that the base 103 may be obtained.

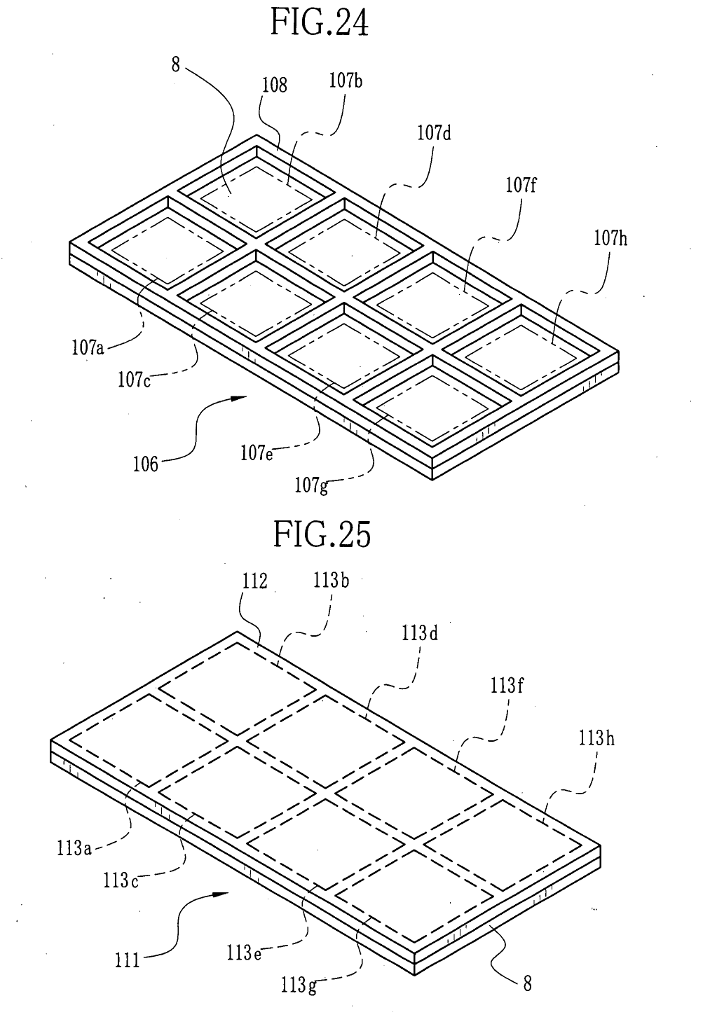

Furthermore, the one honeycomb layer is sectioned by the base having a grid frame, such that a plurality of usable area may be obtained in each frame. As shown in FIG. 24, a honeycomb film 106 has the honeycomb layer 8 and a base 108 as grid frames. Inside each frame of the base 108, there is a usable area 107a-107h.Therefore the grids of the base 108 are disposed outside of the usable areas 107-107h. In this embodiment, the honeycomb film 106 has two grids in width and four grids in length. Note that the number and the arrangement of the grids are not restricted in this embodiment, and can be changed adequately.

In FIG. 25, a honeycomb film 111 includes the honeycomb layer 8 and a base 112 which has perforations 113a-113h. Each perforation 113a-113h is formed so as to be suitable for a size of the usable area. Thus the base 117 is separatable on the perforations 113a-113h without the slitting on the edge of the opening. After the honeycomb layer 8 is formed, inside of each perforation 113a-113h is removed, such that the base 112 may have in each perforation 113a-113h an opening suitable for the size of usable area.

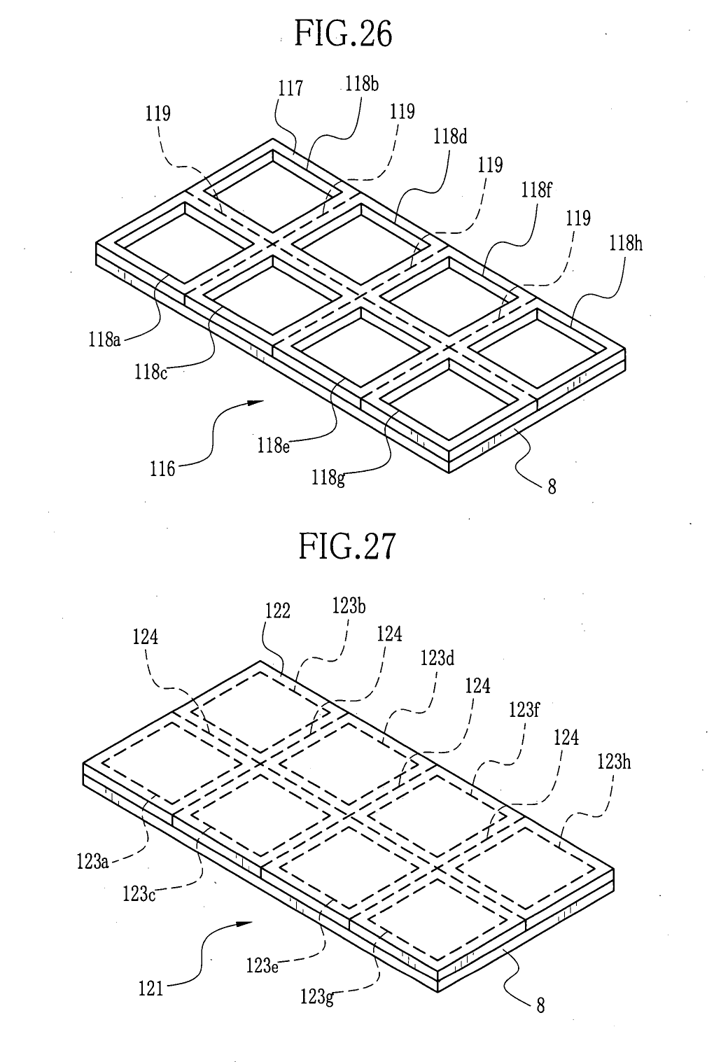

Furthermore, the honeycomb film may be separatable suitably to a product size. In this case, a plurality of film products is obtained from each honeycomb film. In FIG. 26, a honeycomb film 116 includes the honeycomb layer 8 and a base 117 as grid frames that has perforations 119. The perforations 119 are formed suitably to a product size of the film product. Thus the same effects are obtained as the above embodiments, and each grid can be separated on the perforation 119. In FIG. 27, a honeycomb film 121 includes the honeycomb layer 8 and a base 122 which has perforations 123a-123h and perforations 124. The perforations 124 are formed suitable to a product size, and the perforations 123a-123h are formed suitably to the usable area. Note that when a plurality of the film products may be obtained from the one honeycomb film, the number and the arrangement of the film products are not restricted in this embodiment.

In these embodiments, only the base is formed from conductive materials. However, the present invention is not restricted in them. For example, only the honeycomb layer 8 may be formed from the conductive materials, and otherwise both of the honeycomb layer 8 and the base are formed from the conductive materials.

The device for applying the polymer solution to form the wet layer on the base is not restricted in the slide coater of the above embodiment, but a slide coater for forming the multi-layers. Thus a plurality of the polymer solutions is applied on the base to form a wet layers, such that the physical property and the embodiment in the thickness of the honeycomb structure may be changed. Further, instead of the slide coater, an extrusion coater may be used for the applying the polymer solution onto the base.

Further, the applying method of the polymer solution on the base in the present invention, as described in above, is not restricted especially. It may be a sliding method, an extrusion method, a bar coating method, a graver coating method and the like.

The honeycomb film to be obtained by each of the above methods is processed by a process for providing functions, such that other functions are provided for the honeycomb film. For example, the particles of small size, whose reflective index is very different from the honeycomb film, may be applied to the honeycomb film, such that the functional film may be obtained. The functional film is used for producing the photonic crystal or as an optical wave guide or laser waveguide. Further, the particles may be luminescent particles in effect of the photoexitation, conductivity and the like. In this case, the particles are, for example, organic pigment, organic dye, luminescent rare earth compound, and the like. In this embodiment, the process for providing the functions is performed after the production of the honeycomb film. However, instead thereof or in addition thereto, the process for providing the function may be performed in the production process of the honeycomb film. For example, when the particles are contained in the honeycomb film, the particles are previously contained in the polymer solution.

The particle to be used in this embodiment may be provided with magnetism by the optical radiation and the magnetic field. In this case, the magnetism is kept the same level thereafter. When such particles are provided, the functional film which is to be applied to the memory or the recording material is obtained. Further, the coloring ball and the microcapsule can be used as the particles. The functional film in which the particles are provided may be used in a paper like display.

The particle may be materials which can be selectively combined in the chemical reaction to protein, sugar, DNA and the like. The functional film provided with the particles can be used for a biochip. Further, the honeycomb film may be used as a base for cell culturing.

Various changes and modifications are possible in the present invention and may be understood to be within the present invention.

What is claimed is:

1. A porous film comprising:
a base material; and
a porous material formed on said base material so as to have micro pores, said porous material being reinforced by said base material.

2. A porous film described in claim 1, wherein said film material has a thicker part and a thinner part.

3. A porous film described in claim 1, wherein said base material has an asperity part.

4. A porous film described in claim 3, wherein said asperity part is formed by knurling said base material.

5. A porous film described in claim 1, wherein a first surface of said base material contacts to said porous material and has a protrusion higher than a top of said porous material.

6. A porous film described in claim 5, wherein said protrusion contacts to both edges of said porous material.

7. A porous film described in claim 6, wherein edges of said base material is positioned on or outside edges of a product size of said porous material.

8. A porous film described in claim 1, wherein said base material has an opening.

9. A porous film described in claim 1, wherein said base material has perforations or scores for separating part of said base material.

10. A porous film described in claim 1, wherein said porous material is firmly attached to said base material.

11. A porous film described in claim 1, wherein said base material is peelable from said porous material.

12. A porous film described in claim 1, wherein at least one of said base material and said porous material is conductive.

13. A production method of a porous film having a base material and a porous film, comprising steps of:
dissolving a solid material to a solvent, so as to obtain a solution;
applying said solution to said base material so as to form a wet layer on said base material;
forming a liquid droplet in said wet layer;
evaporating said liquid droplet so as to form pores in said wet layer, such that said wet layer may become said porous material.

14. A production method described in claim 13, wherein part of said base material is cut off after the evaporation.

15. A production method described in claim 13, wherein perforations or scores are previously formed on said base material before coating, such that part of said base material may be removable.

16. A production method described in claim 13, wherein at least one of said base material and said porous material is conductive.
